(19) United States
(12) Patent Application Publication
(10) Pub. No.: US 2005/0037259 A1
(43) Pub. Date: Feb. 17, 2005

(54) Thin battery

(76) Inventor: Hiroshi Maruyama, Kusatsu-shi (JP)

Correspondence Address: OSHA & MAY L.L.P., 1221 MCKINNEY STREET, HOUSTON, TX, 77010, US

(21) Appl. No.: 10/501,683

(22) PCT Filed: May 14, 2003
(86) PCT No.: PCT/JP03/05966

(30) Foreign Application Priority Data
May 14, 2002 (JP) 2002-138317

(51) Int. Cl. H01M 2/02; H01M 2/08

(52) U.S. Cl. 429/176; 429/185

(57) ABSTRACT

A thin battery includes a battery module (2) and an outer case (1) for housing the battery module (2), wherein a first case body (1A) and a second case body (1B) include connection walls (8), (18) for connecting the first case body (1A) and the second case body (1B) to each other on outer circumferential portions, at least one of the first case body (1A) and the second case body (1B) includes a dish-shaped case element (5) with a housing portion (7) swelling from one surface and a reinforcing frame (6) fixed to the case element (5) along a circumference of a swelling wall (11) of the housing portion (7), and the battery module (2) is housed in the housing portion (7), whereby a light-weight and small thin battery can be provided, which has sufficient structural strength while the total thickness of the battery is minimized.

### TECHNICAL FIELD

The present invention relates to a card-shaped thin battery used, for example, as a power source of a portable information terminal.

### BACKGROUND ART

The above-mentioned type of battery is known in, for example, JP11(1999)-176400A. In this publication, as shown in FIG. 9, the battery is composed of a battery unit 30, an outer case 31 for housing the battery unit 30, a corrosion-preventive resin sheet 32 for separating the battery unit 30 from the outer case 31, and the like. The battery unit 30 is formed in a flat mat shape with a winding body 33 compressed in an elliptical shape in cross-section, which includes a positive electrode, a negative electrode and a separator, an electrolyte solution, and a container 34 made of a laminated film for housing the winding body 33 and the electrolyte solution. The outer case 31 is composed of an upper case 31a and a lower case 31b connected in a lid-fitting manner. The battery unit 30 is sealed in the upper and lower cases 31a and 31b. The upper and lower cases 31a and 31b respectively are composed of a plate-shaped case wall member 35 obtained by press-forming an aluminum plate material and plastic frames 36 fixed to front and back sides of four circumferential portions of the case wall member 35. For example, the case wall member 35 is subjected to insert molding so as to be integrated with the frames 36 during formation of the frames 36. There also is a battery obtained by subjecting the upper and lower cases to plastics molding in their entirety.

In the above-mentioned battery, the upper and lower cases 31a and 31b are composed of the case wall member 35 made of aluminum and the frames 36 made of plastic. Therefore, the battery can be rendered light-weight. However, since the thick frames 36 are fixed to front and back sides of four circumferential portions of the case wall member 35, the total thickness of the battery cannot help being enlarged, and there is a limit to the reduction in thickness of the battery.

Furthermore, according to the configuration in which the winding body 33 including a positive electrode, a negative electrode, an electrolyte solution, and the like is sealed in the container 34 made of a laminated film to obtain the battery unit 30, and the battery unit 30 is housed in the outer case 31 provided separately from the battery unit 30, the number of components in the entire battery increases, and the production cost of the battery also increases accordingly.

For example, as in a high-energy battery such as a lithium ion battery, a protection circuit for preventing overcharging and overdischarging and further preventing a large current from flowing is added, depending upon the kind of the battery, so as to prepare for unexpected situations. In the above-mentioned card-shaped battery, it is necessary to separately provide a space and an attachment base for setting a protection circuit, which increases the outer shape of the battery accordingly, or involves more labor for incorporating the protection circuit. In this regard, in a conventional battery in which an outer case is formed of a deep-drawn can, the protection circuit cannot help being housed in the outer case, so that a great amount of labor is required for electrical wiring and assembly.

### DISCLOSURE OF INVENTION

The present invention relates to a thin battery comprising a battery module and an outer case for housing the battery module. The outer case includes a first case body and a second case body. The first case body and the second case body include connection walls for connecting the first case body and the second case body to each other on outer circumferential portions. At least one selected from the first case body and the second case body includes a dish-shaped case element with a housing portion swelling from one surface and a reinforcing frame fixed to the case element along a circumference of a swelling wall of the housing portion. The battery module is housed in the housing portion, and the battery module is sealed in the outer case by attaching the connection wall of the first case body to the connection wall of the second case body.

### BRIEF DESCRIPTION OF DRAWINGS

FIG. 1 is a cross-sectional view taken along a line A—A in FIG. 2.

FIG. 2 is a partially cutaway front view showing an example of a thin battery of the present invention.

FIG. 3 is an exploded perspective view showing the example of the thin battery of the present invention.

FIG. 4 is an exploded perspective view showing an example of a first case body.

FIG. 5 is a front view showing main portions in a state where examples of a control module and a cover are disassembled.

FIG. 6 is a cross-sectional view taken along a line B—B in FIG. 2.

FIG. 7 is a cross-sectional view taken along a line C—C in FIG. 2.

FIG. 8 is a cross-sectional view showing main portions of another example of the thin battery of the present invention.

FIG. 9 is an exploded cross-sectional view of a thin battery in a conventional example.

FIG. 10 is an external perspective view showing still another example of the thin battery of the present invention.

FIG. 11 is a perspective view showing main portions before the thin battery shown in FIG. 10 is inserted in an apparatus.

FIG. 12 is a cross-sectional view in a state where the thin battery in shown in FIG. 10 is inserted in the apparatus.

### BEST MODE FOR CARRYING OUT THE INVENTION

Embodiments of the present invention provide a thin battery that has sufficient structural strength while the total thickness of the battery is minimized, and that is preferable as a power source of small electronic equipment strictly required to be light-weight and miniaturized, such as a portable information terminal and the like.

Furthermore, embodiments of the present invention provide a thin battery in which an outer case is allowed to function as a housing container of a battery module, whereby the number of components of the battery is reduced, and the production cost of the battery can be reduced accordingly.

Furthermore, embodiments of the present invention provide a thin battery in which the thickness of a card-shaped thin battery is not required to increase and a control circuit such as a protection circuit can be assembled with respect to an outer case easily and exactly, and which is advantageous for miniaturizing the entire battery provided with the control circuit.

Hereinafter, an embodiment of the present invention will be described with reference to the drawings.

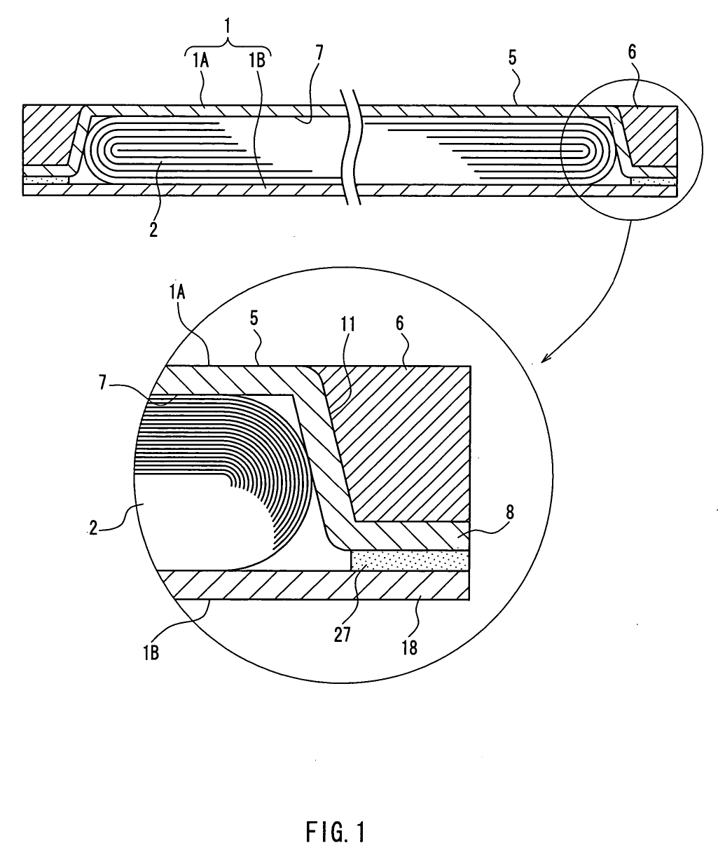

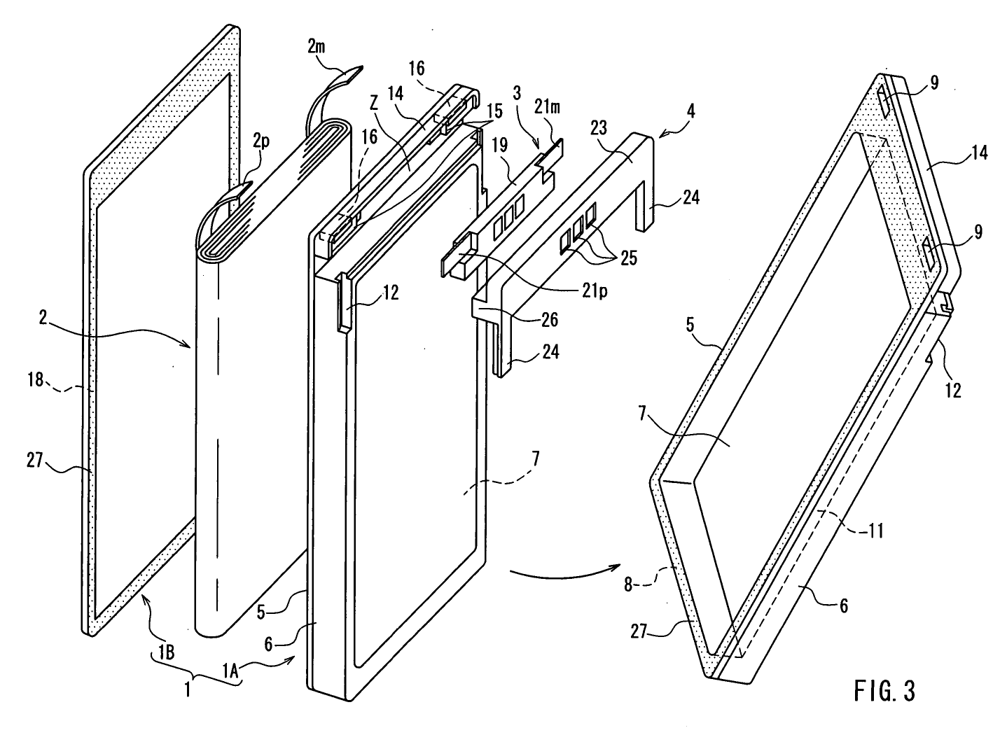

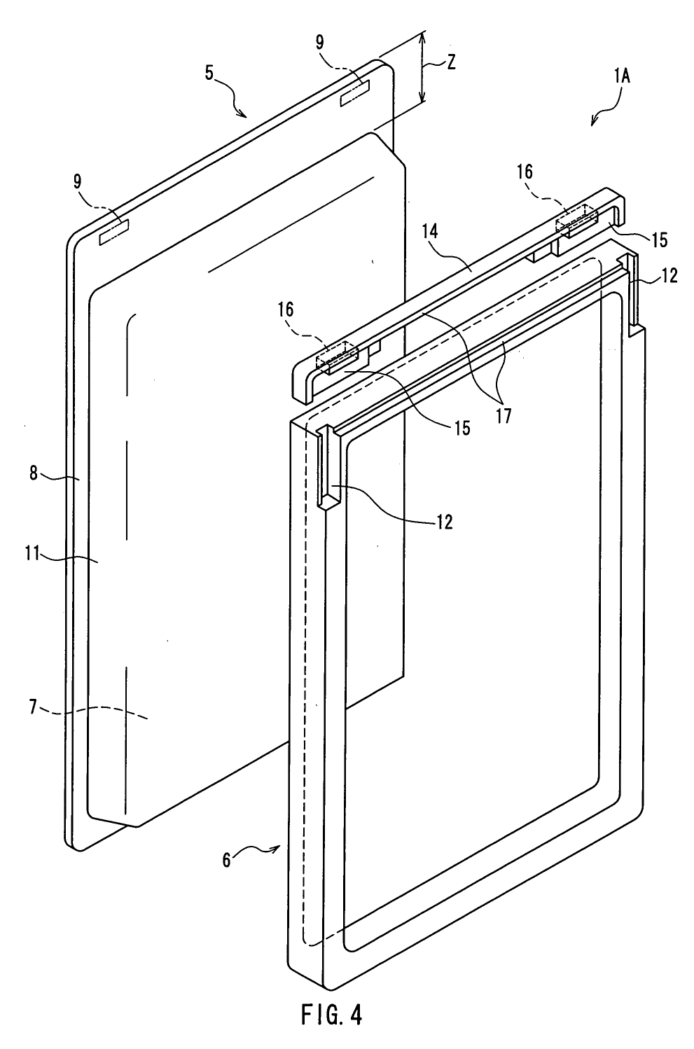

As shown in FIG. 3, an example of a thin battery in accordance with an embodiment of the present invention includes a battery module 2 and an outer case 1 for housing the battery module 2. The outer case 1 is composed of a first case body 1A and a second case body 1B of which outer circumferential edges are connected to each other. As shown in FIG. 4, at least one of the first and second case bodies 1A and 1B is composed of a dish-shaped case element 5 in which a housing portion 7 swells from one surface, and a reinforcing frame 6 fixed to the case element 5 along the circumference of a swelling wall 11 of the housing portion 7. Furthermore, as shown in FIG. 1, the battery module 2 housed in the housing portion 7 is sealed in the outer case 1 by attaching connection walls 8 and 18, provided on circumferential edges of the first and second case bodies 1A and 1B, to each other.

More specifically, the reinforcing frame 6 is a plastic molding, the case element 5 is a press-formed product made of a metal thin plate, and the case element 5 is inserted into a mold during molding of the reinforcing frame 6 to be integrated with the reinforcing frame 6.

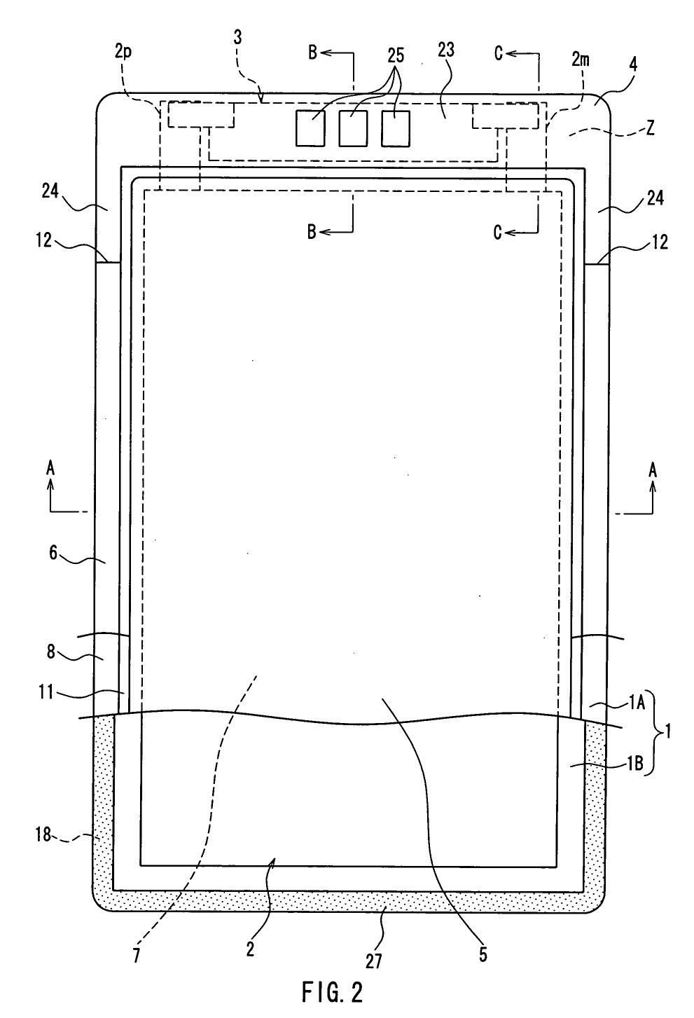

On an outer surface of the connection walls 8, 18 of the first case body 1A and the second case body 1B, adjacent to the swelling wall 11 of the housing portion 7, a mounting region Z is kept, as shown in FIG. 2, and a control module 3 for the battery module 2 and a cover 4 for protecting the control module 3 are provided in the mounting region Z.

The control module 3 includes a protection circuit, a positive output terminal, and a negative output terminal. As shown in FIG. 7, a pair of input terminals 21p and 21m of the control module 3 are connected to be fixed to a positive tab 2p and a negative tab 2m of the battery module 2 led to the mounting region Z, whereby the control module 3 can be fixed to the mounting region Z.

The mounting region Z is provided on one side of the outer case 1 formed in a rectangular card shape. As shown in FIG. 2, the cover 4 is composed of a principal plane wall 23 covering the outer surface of the control module 3, and a pair of leg chips 24 projecting from both side ends of the principal plane wall 23, and terminal windows 25 for exposing output terminals 20 of the control module 3 are opened on the principal plane wall 23.

The outer case 1 of the present embodiment is composed of the first case body 1A and the second case body 1B, and the battery module 2 is sealed in the housing portion 7 provided between the case bodies 1A and 1B. That is, the outer case 1 also functions as a housing container of the battery module 2 to minimize the total thickness of the battery and reduce the number of components of the battery. Thus, according to the present invention, a thinner and lighter battery is obtained, and the production cost of the battery can be reduced by a decreased number of components.

When the case element 5 of at least one of the first and second case bodies 1A and 1B is reinforced with the reinforcing frame 6, the reinforcing frame 6 is placed around the swelling wall 11 of the housing portion 7 to reinforce the case element 5. Therefore, while the thickness of the battery is prevented from being increased, the structural strength of the battery can be enhanced sufficiently. Thus, in spite of thinness, a battery strong to bending stress and drop impact can be obtained. That is, a thin battery preferable as a power source of small electronic equipment such as a portable information terminal or the like, which is strictly required to be light-weight and miniaturized, can be obtained.

When the previously press-formed case element 5 is inserted into a mold during molding of the reinforcing frame 6 to be integrated with the reinforcing frame 6, the number of processing of the first and second case bodies 1A and 1B can be reduced compared with the case where the reinforcing frame 6 is molded to be fixed to the case element 5, and the positioning accuracy between the case element 5 and the reinforcing frame 6 also is enhanced.

In a thin battery in which the mounting region Z is provided on the outer surface of the connection walls 8, 18 of the first case body 1A and the second case body 1B, the control module 3 and the cover 4 only need to be incorporated successively into the mounting region Z exposed to the outer surface of the outer case 1. Therefore, the assembly operation of the control module 3 and the cover 4 with respect to the outer case 1 can be performed easily and exactly. By adding the control module 3 and the cover 4, the thickness of the card-shaped thin battery is not increased, and the entire battery provided with this type of control circuit can be miniaturized. Since all the electrical components such as a protection circuit are integrated to form one control module 3, the labor for connecting the control module 3 to the battery module 2 can be saved. The outer surface of the control module 3 is covered with the cover 4, so that the adhesion of foreign matter to the mounting components of the control module 3, and inconvenience such as a short-circuit can be prevented exactly.

In a thin battery in which the positive tab 2p and the negative tab 2m of the battery module 2 are led to the mounting region Z, and a pair of input terminals 21p and 21m of the control module 3 are connected to be fixed to the tabs 2p and 2m, whereby the control module 3 is fixed to the mounting region Z, the control module 3 can be incorporated to the battery with minimum labor only for mounting the control module 3 at a predetermined position and connecting the input terminals 2p and 21m. Furthermore, an assembly operation can be performed while confirming that an assembled battery is in a state according to the specifications, and further confirming that the control module 3 is normal. Therefore, defective products can be minimized at the completion of assembly.

In a battery in which the cover 4 is composed of the principal plane wall 23 covering the outer surface of the control module 3 and a pair of leg chips 24 projecting from both side ends of the principal plane wall 23, and the terminal windows 25 for exposing the output terminals 20 of the control module 3 are opened to the principal plane wall 23, a region of the control module 3 other than the output terminals 20 is covered with the cover 4 completely, and the control module 3 can be protected exactly. The principal plane wall 23 and a pair of leg chips 24 cooperate to oppose to the outer force. Therefore, for example, the cover 4 can be prevented from being separated from the battery due to drop impact.

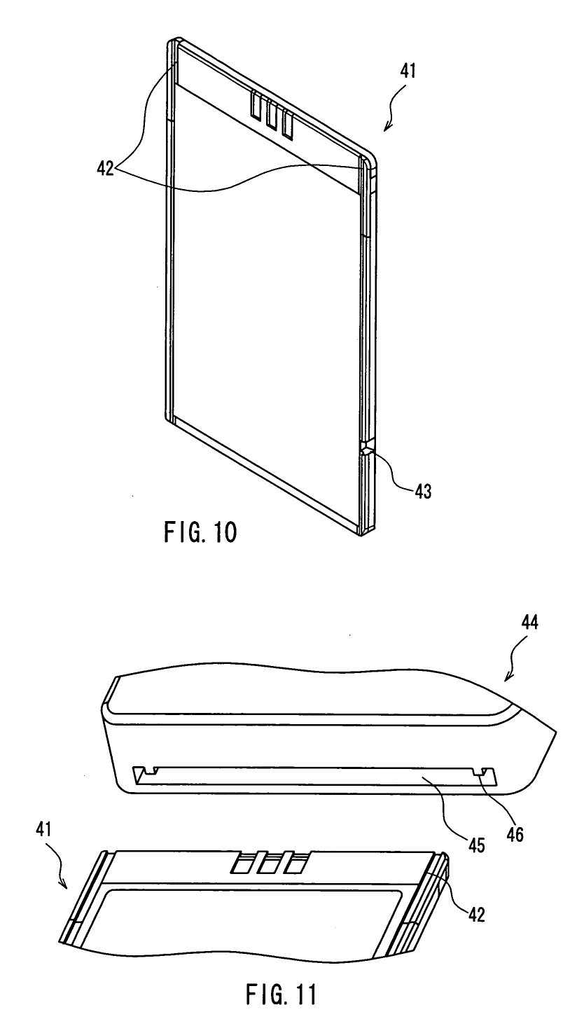

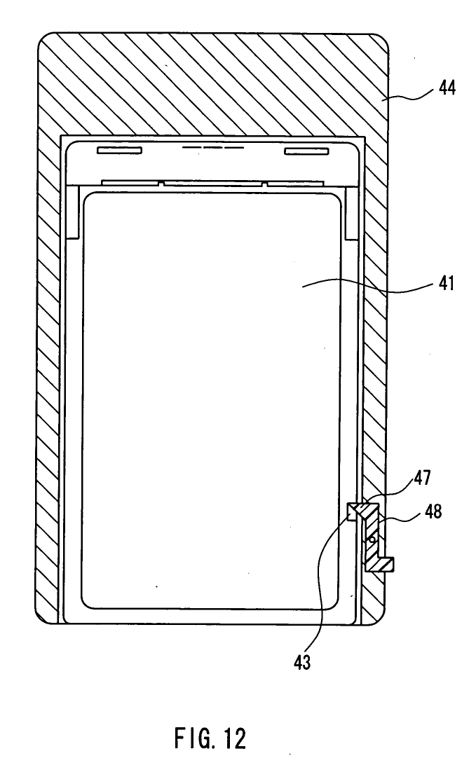

Furthermore, another example of the thin battery of the present invention will be described with reference to FIGS. 10 to 12. In the present embodiment, concave portions 42 for preventing reverse insertion are formed in side portions of an outer case, and the concave portions 42 for preventing reverse insertion are configured so as to be engaged with convex portions 46 for preventing reverse insertion provided in a battery insertion portion 45 of an apparatus 44 in which a thin battery 41 is to be mounted. This can prevent erroneous insertion such as reverse insertion when the thin battery 41 is inserted to the apparatus 44.

Furthermore, in the present embodiment, in a side portion of the outer case, a concave portion 43 for preventing dropping is formed so as to be engaged with a convex portion 47 for preventing dropping of a dropping preventing machine 48 provided in the apparatus 44 in which the thin battery 41 is to be mounted. Because of this, even when strong impact is applied to the apparatus 44 in which the thin battery 41 is inserted and mounted, the thin battery 41 does not drop easily.

Next, the present invention will be described by way of an example.

FIGS. 1 to 7 show an example of a thin battery according to the present invention. In FIGS. 2 and 3, the thin battery is composed of an outer case 1, a battery module 2 and an electrolyte sealed in the outer case 1, and a control module 3 and a cover 4 incorporated to an outer surface side of the outer case 1. The outer case 1 is composed of a first case body 1A and a second case body 1B connected in a lid-fitting manner.

In FIG. 4, the first case body 1A is composed of a case element 5 made of a press-formed product, and a reinforcing frame 6 fixed along an outer circumferential edge of the case element 5. In FIG. 4, in order to clarify the structural relationship between the case element 5 and the reinforcing frame 6, they are shown as being disassembled.

The case element 5 is made of an aluminum thin plate (thickness: about 0.1 to 0.2 mm). A housing portion 7 in a vertically long rectangular shape swells from one surface of the case element 5, and a connection wall 8 projects in a rectangular dish shape from an outer circumference of the housing portion 7. The connection wall 8 is formed narrow on right and left sides and a lower side of the housing portion 7, and is formed wide on an upper side thereof. This is because most of the upper side portion of the connection wall 8 formed wide is used as a mounting region Z for the control module 3. At right and left two portions on an upper side of the mounting region Z, electrode leading ports 9 are to be opened in a later step.

The reinforcing frame 6 is made of a plastic molding in a rectangular frame shape, and is arranged along an outer circumference of the tilted swelling wall 11 of the housing portion 7 to be fixed to an outer surface of the connection wall 8 of the case element 5. In the present example, the case element 5 is inserted in a mold during injection molding of the reinforcing frame 6 to be integrated with the connection wall 8. When the case element 5 is inserted to be fixed to the reinforcing frame 6, labor for attaching the reinforcing frame 6 to the case element 5 can be saved, so that the production steps of the battery can be reduced accordingly. In order to prevent the thickness of the battery from increasing, the thickness of the reinforcing frame 6 is set to be the same as that of the swelling size of the housing portion 7, as shown in FIG. 1, and the outer surface of the reinforcing frame 6 is flush with the outer surface of the housing portion 7. On both sides of an upper end of the reinforcing frame 6, connection sections 12 for attaching a cover 4 are formed in a concave shape (see FIG. 4).

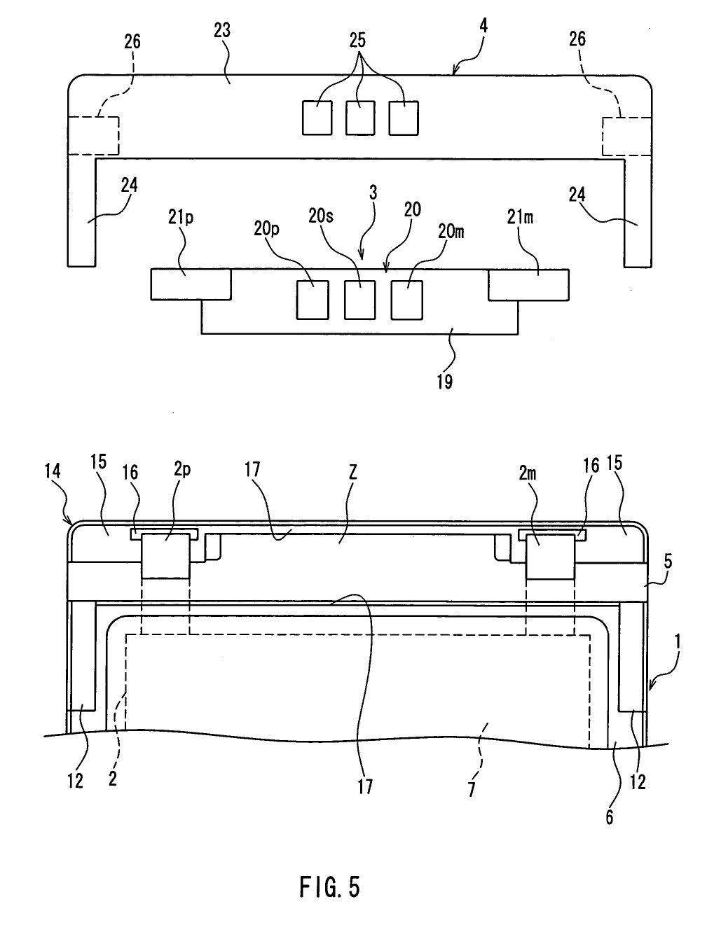

A horizontally oriented receiving frame 14 is provided above the reinforcing frame 6 so as to be placed along an upper edge of the mounting region Z. The receiving frame 14 is formed simultaneously with the reinforcing frame 6 to be fixed to the mounting region Z. In FIGS. 4 and 5, connection sections 15 for fixing a positive tab 2p and a negative tab 2m of the battery module 2 described later are formed on both lower sides of the receiving frame 14, and an opening 16 corresponding to the electrode leading port 9 is formed in each connection section 15. Connection sections 17 for attaching a cover 4 in a manner described later are formed respectively on the receiving frame 14 and an upper frame portion of the reinforcing frame 6 (see FIG. 4).

In FIG. 3, the second case body 1B is made of a lid in a plate shape obtained by punching an aluminum thin plate into the same outer shape as that of the first case body 1A, and by attaching a connection wall 18 on an outer circumferential edge of the second case body 1B to the connection wall 8 of the first case body 1A, the housing portion 7 can be closed. In order to set the connection strength between the connection walls 8 and 18 to be sufficient, and enhance the sealing degree of the connection surface, a thermoplastic connection resin 27 is bonded to at least one of the connection walls 8 and 18 before connection between the connection walls 8 and 18.

The battery module 2 is configured by winding a sheet-shaped positive electrode containing LiCoO₂ as an active material and a sheet-shaped negative electrode containing graphite as an active material in a spiral shape with a separator interposed therebetween, and deforming the wound structure in an oval shape in cross-section by pressing. The positive tab 2p and the negative tab 2m are led respectively at winding ends of the positive electrode and the negative electrode, as shown in FIG. 2.

In FIG. 5, the control module 3 has a configuration in which a protection circuit composed of an IC chip, a switch for disconnecting a circuit, and the like, a polyswitch, etc. are mounted on a reverse surface of a substrate 19, and three output terminals 20 are placed at the center of a front surface of the substrate 19. The protection circuit prevents the battery from being in an overcharging state or an overdischarging state, and the polyswitch prevents a large current from flowing to cause thermal destruction. The output terminals 20 are composed of a positive output terminal 20p and a negative output terminal 20m positioned on right and left sides and a signal output terminal 20s at the center. Input terminals 21p and 21m to be connected to the positive tab 2p and the negative tab 2m of the battery module 2 are fixed to the right and left sides of the substrate 19. The signal output terminal 20s is provided so as to be used, for example, for detecting the resistance of an ID resistor incorporated into the substrate 19 together with the protection circuit and determining whether or not the battery is appropriate on the electronic equipment side.

In FIG. 5, the cover 4 is made of a plastic molding in a gate shape obtained by integrally molding a principal plane wall 23 covering the outer surface of the control module 3 and a pair of leg chips 24 projecting downward from right and left sides of the principal plane wall 23. Three terminal windows 25 for exposing the output terminals 20 (20p, 20m, 20s) of the control module 3 are opened on the right and left sides and at the center of the principal plane wall 23. Block plugs 26 for dosing gaps between the receiving frame 14 and the reinforcing frame 6 project from right and left sides of the reverse surface of the principal plane wall 23.

The summary of an assembly procedure of the battery will be described. First, the battery module 2 is mounted in the housing portion 7 of the first case body 1A. The positive and negative tabs 2p and 2m are inserted into the electrode leading ports 9 and the openings 16. Thereafter, as shown in FIG. 7, the positive and negative tabs 2p and 2m are bent to be inverted, and exposed to the outer surfaces of the connection sections 15. At this time, in order to prevent the positive and negative tabs 2p and 2m from coming into direct contact with the electrode leading ports 9, the tabs 2p and 2m are covered with an insulating tape at some midpoint.

Next, the housing portion 7 is filled with an electrolyte (non-aqueous electrolyte). Under this condition, the second case body 1B is connected to the first case body 1A in a lid-fitting manner, and the connection walls 8 and 18 of the first case body 1A and the second case body 1B are pressed with heating, whereby the connection resin 27 is melted and then, solidified. Thus, the battery module 2 is sealed in the outer case 1.

The control module 3 is mounted in a blank battery obtained as described above, and the cover 4 is fixed thereto, whereby a thin battery is completed. More specifically, the input terminals 21p and 21m of the control module 3 are overlapped with the positive and negative tabs 2p and 2m bent to be inverted to the connection sections 15, and are subjected to spot welding, whereby the control module 3 is connected to the battery module 2 electrically. In this state, the control module 3 is positioned in a space between the reinforcing frame 6 and the receiving frame 14 to be housed therein, and the vertical and horizontal floating of the control module 3 is restricted.

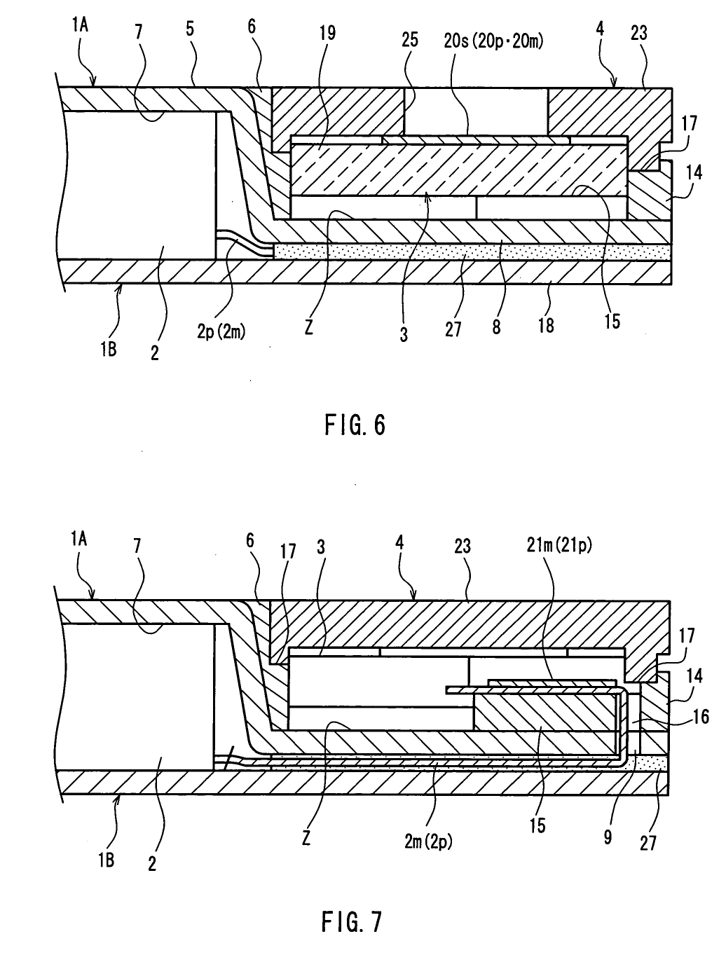

Finally, the cover 4 is placed on the mounting region Z, and the vertical movement of the principal plane wall 23 is restricted by the connection sections 17 of the reinforcing frame 6 and the receiving frame 17, as shown in FIG. 6. Furthermore, the right and left leg chips 24 are engaged with the connection sections 12 (see FIG. 2). Under this condition, the principal plane wall 23 and the leg chips 24 are ultrasonically welded to the receiving frame 14 and the reinforcing frame 6, whereby the cover 4 is fixed. In this state, the control module 3 is interposed between the principal plane wall 23 and the connection wall 8 in the front and back directions, and only the output terminals 20 (20p, 20m, 20s) are exposed to the outside of the cover from the terminal windows 25 (see FIG. 6). Furthermore, both side ends of the mounting region Z between the receiving frame 14 and the reinforcing frame 6 are closed with the block plugs 26 provided at the cover 4.

The total thickness of the completed thin battery is equal to the total thickness of the first and second case bodies 1A and 1B, and the total thickness in the mounting region Z also is equal to the total thickness of the completed thin battery. The size of the outer shape of the thin battery in this example is 90×54×2.5 mm (height×length×thickness). The output voltage thereof is 3.8 V, and the battery capacity thereof is 1000 mAH.

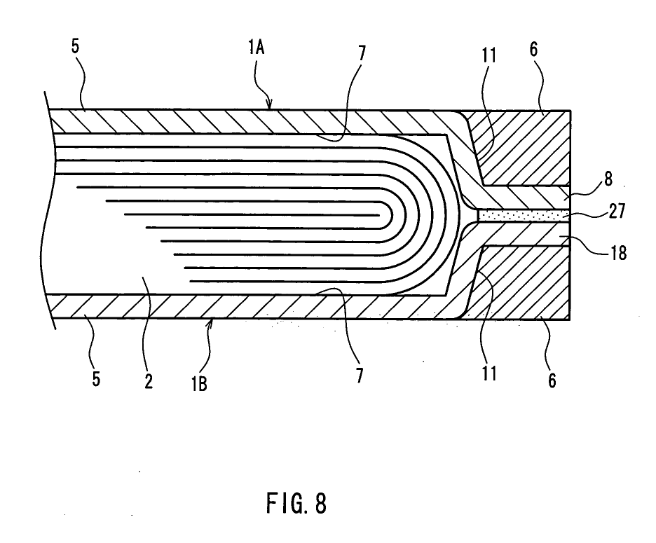

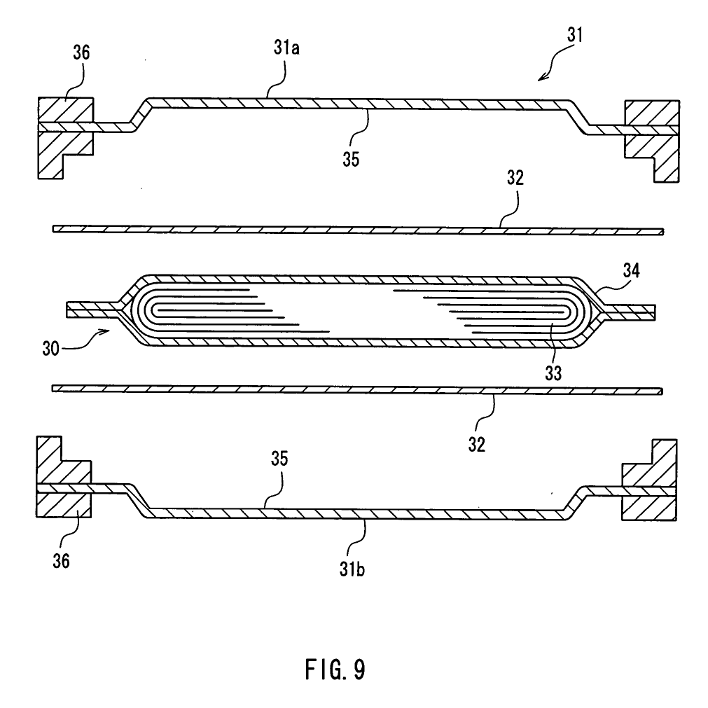

In the above-mentioned example, the housing portion 7 is provided only in the first case body 1A. However, as shown in FIG. 8, the housing portion 7 also may be provided in the second case body 1B, and the reinforcing frame 6 also may be attached to the outer circumference thereof.

In addition to the above, the following also can be performed. The reinforcing frame 6 is molded previously, and bonded or welded to be fixed to the connection wall 8. The outer shape of the outer case 1 is not required to be a rectangle, and can be varied into an arbitrary shape depending upon the configuration and shape of electronic equipment to which the battery is applied. The first case body 1A and the second case body 1B may be formed of a stainless thin plate or a plated thin steel plate, and can be fixed by bonding with an adhesive or seam welding. The first case body 1A and the second case body 1B may be made of different materials. The mounting region Z can be provided at a plurality of portions of the outer circumference of the outer case 1. The receiving frame 14 may be integrally molded with the reinforcing frame 6. The cover 4 can be integrally molded with the receiving frame 14 via an integrally molded hinge. The thin battery of the present invention also is applicable to batteries other than a lithium ion battery.

Furthermore, FIGS. 10 to 12 show another example of the thin battery according to the present invention. In the present example, concave portions 42 for preventing reverse insertion further are formed on sides of the outer case, and the concave portions 42 for preventing reverse insertion are to be engaged with convex portions 46 for preventing reverse insertion provided in a battery insertion portion 45 of an apparatus 44.

Furthermore, in the present example, a concave portion 43 for preventing dropping further is formed on a side of the outer case, and the concave portion 43 for preventing dropping are to be engaged with a convex portion 47 for preventing dropping of a dropping preventing machine 48 provided in the apparatus 44 in which the thin battery 41 is to be mounted.

### INDUSTRIAL APPLICABILITY

The present invention can provide a thin battery that has sufficient structural strength while the total thickness of the battery is minimized, and that is preferable as a power source of a portal information terminal or the like strictly required to be light-weight and miniaturized.

1. A thin battery comprising a battery module and an outer case for housing the battery module,
wherein the outer case includes a first case body and a second case body,
the first case body and the second case body include connection walls for connecting the first case body and the second case body to each other on outer circumferential portions,
at least one selected from the first case body and the second case body includes a dish-shaped case element with a housing portion swelling from one surface and a reinforcing frame fixed to the case element along a circumference of a swelling wall of the housing portion,
the battery module is housed in the housing portion, and
the battery module is sealed in the outer case by attaching the connection wall of the first case body to the connection wall of the second case body.

2. The thin battery according to claim 1, wherein the reinforcing frame is made of a plastic molding, the case element is a press-formed product made of a metal thin plate, and the case element is formed so as to be integrated with the reinforcing frame.

3. The thin battery according to claim 1, wherein a mounting region further is formed on an outer surface of the connection wall adjacent to the swelling wall of the housing portion, and the mounting region includes a control module for the battery module and a cover for protecting the control module.

4. The thin battery according to claim 3, wherein the control module includes a protection circuit, output terminals and input terminals, and a pair of the input terminals of the control module are connected to be fixed to a positive tab and a negative tab of the battery module led to the mounting region, whereby the control module is fixed to the mounting region.

5. The thin battery according to claim 3, wherein the outer case is formed in a rectangular card shape, the mounting region is provided on one side of the outer case, the cover includes a principal plane wall covering an outer surface of the control module and a pair of leg chips projecting from both ends of the principal plane wall, and terminal windows for exposing the output terminals of the control module are opened in the principal plane wall.

6. The thin battery according to claim 1, wherein a concave portion for preventing reverse insertion further is formed on one side of the outer case, and the concave portion is engaged with a convex portion for preventing reverse insertion provided in a battery insertion portion of an apparatus in which the battery is to be mounted.

7. The thin battery according to claim 1, wherein a concave portion for preventing dropping further is formed on one side of the outer case, and the concave portion is engaged with the convex portion for preventing dropping provided in an apparatus in which the battery is to be mounted.
